(19) United States
(12) Patent Application Publication
(10) Pub. No.: US 2010/0316267 A1
(43) Pub. Date: Dec. 16, 2010

(54) SEGMENTATION

(75) Inventors: Thomas Buelow, Grosshansdorf (DE); Rafael Wiemker, Kisdorf (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/446,471

(22) PCT Filed: Oct. 22, 2007
(86) PCT No.: PCT/IB07/54275

§ 371 Date: Apr. 21, 2009

(51) Int. Cl. G06K 9/00

(52) U.S. Cl. 382/128

(57) ABSTRACT

A computer program product, segmentation algorithm, display image product, workstation and PACS system are disclosed, all allowing the closing of holes, or gaps, in failed segmentation algorithms. This is achieved by identifying at least one data point not included in the collection of data points identified by the segmentation algorithm and deriving a measure of the percentage of radial directions around that data point which intersect at least one detected data point in the segmentation, further including the newly identified data point into the segmentation only if the calculated percentage of radial directions is above a pre-determined threshold. The problem of holes and gaps in segmented lesions was previously only solved by amending the steps of the segmentation algorithm or by morphological reconstruction, which latter method requires use of structuring elements themselves not suitable for large holes.

### FIELD OF THE INVENTION

The invention relates to a computer program product to operate on a medical dataset containing data points and in which an algorithm has detected the collection of data points within the medical dataset which represent a target object.

### BACKGROUND OF THE INVENTION

Various methods for segmentation of objects within medical images, and computer programs by which such methods can be applied, are known in the field of medical imaging, for example “A method for computerized assessment of tumor extent in contrast-enhanced MR images of the breast”, K G A Gilhuijs et al, Computer-Aided Diagnosis in Medical Imaging, ed. K Doi, H MacMahon, M L Geiger and K R Hoffmann, 1999, Elsevier Science and “Segmentation Strategies for Breast Tumors from Dynamic MR Images”, Flora Ann Lucas-Quesada et al, JMRI, 1996, Volume 6, Number 5: 753-763. Both documents detail methods of performing segmentation, in both cases involving the segmentation of breast lesions. It is further known that segmentation methods can fail to some extent to segment the entire lesion apparent in the image or dataset. It is frequently found in the art that the segmentation result includes visible defects such as holes in the center of the identified lesion where, for example, the segmentation has failed to detect necrotic areas of a lesion and undulations and missing portions visible around the edge of the lesion where the segmentation algorithm has failed to correctly identify edge portions of the lesion. An attempt is made to solve this problem in “A Fuzzy C-Means (FCM)-Based Approach for Computerized Segmentation of Breast Lesions in Dynamic Contrast-Enhanced MR Images”, Weijie Chen et al, Academic Radiology, Bol. 12, No. 1, January 2006, 63-72 where the segmentation is completed with a step described as ‘Hole Filling’ and which is achieved via morphological reconstruction. However, the steps of morphological reconstruction, such as dilation and erosion, can, as detailed in “3D Digital Cleansing Using Segmentation Rays”, Sarang Lakare et al, Proceedings Visualization 2000, 37-44, depending on the order in which they are performed, be used to fill in holes or to remove noise. However, it is also known that morphological reconstruction requires use of a structuring element and in the case of large holes, i.e. large necrotic areas in contrast enhanced lesion detection, the large structuring element may distort the outer contour of the lesion.

### SUMMARY OF THE INVENTION

It is an object of the invention to provide an improved technique which when used to repair holes in a segmented object will repair any unsegmented portions of the object regardless of size.

This is achieved according to the invention by which the computer program product is arranged to identify at least one data point not included in the collection and to derive a measure of the percentage of radial directions around that data point which intersect at least one detected data point in the collection, and further arranged, conditional upon the calculated percentage of radial directions being above a pre-determined threshold, to include that data point in the collection of detected data points representing the target object.

Assuming that some degree of segmentation has already occurred, being either the application of a full segmentation algorithm or sufficient steps of a segmentation algorithm to allow some identification of the shape of the object sought, either in two dimensions or three, the computer program product can be applied to the identified lesion to close any gaps in the full segmentation of the object.

There are two steps in the application of the invention. The first is to derive a measure for non-segmented data points, in other words for pixels or voxels in the image which have been excluded from the segmentation procedure already undergone, of the extent to which the included portion of the image data surrounds the non-segmented data points.

The second step is to compare this measure to a pre-determined threshold and, for any data points for which the measure is above the threshold, include them in the segmentation.

These two steps together ensure that not only are segmentation holes in the body of the segmented lesion repaired, but that missing sections from the edge of the lesion are also repaired.

The holes or gaps closed by the invention are usually immediately visually apparent to the trained and clinically knowledgeable viewer upon seeing the output of the segmentation process, but are notoriously resistant to inclusion in normal segmentation algorithms. Much work has been devoted to producing segmentation algorithms which produce an output representing completely the object or lesion of interest, but most work in this area has concentrated on modifying steps within the segmentation algorithm and as such succeeds in repairing holes in some applications of the segmentation algorithm, but not in others. As an alternative approach, the computer program of the invention takes as input a segmentation or segmentation of sorts and attempts to complete it.

The program of the invention is particularly useful when applied to contrast enhanced tumor detection because segmentation methods applied to detection of these lesions is frequently threshold based. Such segmentation methods contain a step which identifies all data points, i.e. pixels or voxels, with numerical value is above a certain threshold and this step frequently excludes data points representing tissue with a low contrast uptake. In this way segmentation methods applied to contrast enhanced tumor detection frequently miss both central necrotic portions of the tumor and edge portions of very small tumor thickness.

In particular, it is found that the program of the invention is advantageously applied to the detection of contrast enhanced breast lesions, although it can be applied to any segmentation of lesions where the segmentation output contains holes or gaps corresponding to unsegmented lesion.

The computer program can be included as an automatic last step at the end of a normal segmentation algorithm or can be offered to the user as a repair program which can be manually selected to run in the instances when the normally applied segmentation algorithm has produced an output with visually apparent holes or gaps.

The invention has the further advantage that it can be used to repair holes and gaps at the edge of segmented lesions. Morphological reconstruction is not always successful in cases where the segmentation algorithm fails to include edge portions of the lesion.

There are various ways in which the measure can be derived.

The invention is based on a measure of the extent by which a particular point excluded from the prior segmentation steps is in fact interior to the object undergoing segmentation. In order to evaluate this for a given point, a measure of this extent is calculated. A particularly advantageous manner in which this can be achieved is to cast rays outwards from the point in question and through the dataset. The percentage of rays which intersect the segmented structure thereby becomes the measure of the extent by which the point is interior to the object. In order to softly close unsegmented areas a threshold is chosen. All voxels exhibiting a measure of extent value higher than this threshold are considered inside the lesion and added to the segmented structure.

This embodiment produces more successful results if the rays cast are angularly radially distributed about the data point.

One simple variation would be to change the order of operations. An embodiment of this, as an example, is to first cast rays in one direction through the entire volume and increment a counter on background voxels that lie on rays that intersect with the object, repeating the procedure for the next direction and so on. This still involves ray-casting but processes the whole volume rather than computing the measure for the individual volume separately.

Alternatively, it is possible to calculate a circle, in the case of a two dimensional image calculation, or a sphere in the case of a three dimensional image calculation, in each case centered around the excluded data point and use as the measure the proportion of the circumference intersecting the already segmented portions. Selection of the most meaningful radius is challenging but, for example, one solution would be to generate results for a series of different radii for each data point and derive the measure from the integration of all the results, or derive it from the radius which produces the highest proportional result.

In order to achieve a close to regular sampling of the rays around each chosen data point a subdivided icosahedron can be used when the calculation is performed in a three dimensional dataset.

In a particularly advantageous embodiment, the computer program progresses through the data set on a point by point basis, in other words, taking each data point and performing the calculation for that data point before moving on to the next. In principle it is possible to perform the steps of the invention for each non-segmented data point throughout the entire dataset but this is computationally very intensive and a more advantageous and iterative approach is to start with the data points on the edge of the already segmented portions, performing calculations for these according to the invention but not adding them into the segmentation until all calculations have been completed. Iteratively, the calculations are then further performed for all data points next to data points for which the calculation of the measure was above the threshold. If this approach is followed it is found that for some of the data points the calculation of the measure will be below the threshold and these data points can be further ignored. The iteration continues until there are no data points left for which calculation of the measure is above the threshold. All data points for which the calculation of the measure was indeed above the threshold are then added to the segmentation volume.

The threshold is found advantageously to be between 70% and 90% depending on the application. It is advantageous for the user to be able to vary the threshold interactively, in particular upon viewing the results of the repair operation and in this case it is found that in the majority of cases where the lesion has essentially a rounded shape the user frequently chooses a threshold between 75% and 85%. In fact, for contrast enhanced breast lesions a threshold of 80% is found to give the most satisfactory results.

The invention also relates to a segmentation algorithm comprising the steps of the invention. Such a segmentation algorithm has the advantage that it incorporates the steps of the invention and these can be applied to any intermediate output segmentation volume generated within the segmentation. The steps of the invention can then be used to repair any holes or gaps before either continuation with the remainder of the segmentation process or presentation of the final result to the user.

The invention also relates to a computer program product arranged to display images acquired from medical imaging equipment comprising a computer program product including the steps of the invention. Such a computer program product has the advantage that it can be used to display and view medical images and use the steps of the invention to repair the output of segmentation algorithms.

The invention also relates to a workstation comprising a computer program product comprising the steps of the invention and to a PACS system comprising a computer program comprising the steps of the invention. Both have the advantage that they can be used to display and view medical images and use the steps of the invention to repair the output of segmentation algorithms.

The skilled person, once he understands the steps to be achieved, will be able to construct a computer program as in known in the art implementing the steps of the invention.

### BRIEF DESCRIPTION OF THE DRAWINGS

These and other aspects of the invention will be explained with the assistance of the following figures.

FIG. 1 shows a lesion suitable for the application of the invention.

FIG. 2 shows the same lesion after application of the invention.

FIG. 3 shows how the invention achieves its goal.

### DETAILED DESCRIPTION OF THE EMBODIMENTS

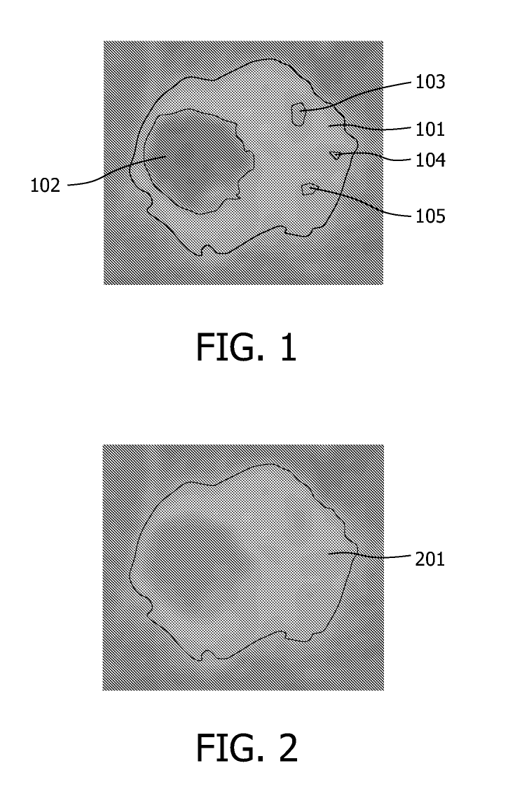

FIG. 1 shows an MR image of a contrast enhanced breast lesion 101 segmented at an automatically determined threshold. The large necrotic kernel 102 has not been included in the segmentation as well as a couple of smaller portions 103, 104, 105 that were missed due to inhomogeneous contrast uptake.

Most methods for the segmentation of breast lesions from dynamic contrast enhanced MRI rely on intensity threshold methods due to the large morphologic variety of lesions. In case of inhomogeneous enhancement of the lesion it is found that interior portions of the lesion may be missed by existing segmentation procedures.

However, accurate filling of these missed interior parts of the lesions allow accurate volume assessment, morphologic assessment of the outer contour and correct quantification of the heterogeneity of contrast uptake. Manual filling is time consuming. In addition, closing portions fully enclosed within the 3D set of segmented voxels will miss all non-enhancing lesion parts that are connected through tunnels with the background. Further, morphologic closing operations require a structuring element of a given size. In order to close even large necrotic kernels as in the example above large structuring elements need to be applied, which would at the same time distort the outer contour of the lesion.

FIG. 2 shows the same lesion 201 after application of the invention. All holes are now filled.

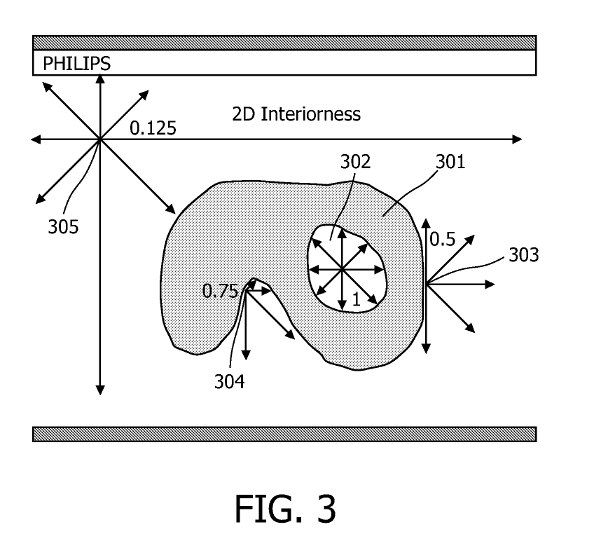

FIG. 3 shows how the invention achieves its goal and shows a segmented volume 301. If the measure of the percentage of radial directions around the data point for points 302, 303, 304, 305 are calculated it is shown that the calculation of the measure for point 302 has the value of 100%, or 1, and is therefore included in the segmentation. So will all points in the hole shown. The calculation for points 303, 304 and 305 are 50%, or 0.5, 75%, or 0.75 and 0.125 respectively, and these points are not included in the results of the segmentation.

The following procedure, a form of prioritized region growing, is also found to be particularly suitable for use in restricting the number of voxels for which the measure must be evaluated:
1. Compute the measure for all boundary voxels. The set of boundary voxels contains the voxels with the highest measure of extent by which they reside within the object to be segmented.
2. If the measure is above the given threshold, include the corresponding voxel in the set of segmented voxels, otherwise terminate.
3. Update the list of boundary voxels and compute the interiorness for new boundary points.
4. Return to 1.

The procedure can be applied in 2D as well as in 3D.

This invention provides a way of closing interior portion of a segmented area even if this area is not strictly contained within the segmented area. The proposed method works independently of the size of the segmented area and of the holes to be closed.

The extent to which a data point must be interior to the object in order to be included in the segmented area can be tuned by a single continuous parameter, a measure of the extent by which the already segmented object surrounds that point, and that can be interactively changed by the user if desired by changing the threshold.

1. A computer program product to operate on a medical dataset containing data points and in which an algorithm has detected a collection of data points within the medical dataset which represent a target object, characterized in that
the computer program product is arranged to identify at least one data point not included in the collection and to derive a measure of a percentage of radial directions around that identified data point which intersect at least one detected data point in the collection,
and further arranged, conditional upon the calculated percentage of radial directions being above a pre-determined threshold, to include that identified data point in the collection of detected data points representing the target object.

2. A computer program product as claimed in claim 1 characterized in that it is arranged to cast rays outwards from the identified data point and calculate the percentage of rays which intersect at least one detected data point in the collection.

3. A computer program product as claimed in claim 2 characterized in that the cast rays are angularly radially distributed around the identified data point.

4. A computer program product according to claim 1 characterized in that multiple data points are identified and their identification progresses on a point by point basis through the dataset.

5. A computer program as claimed in claim 4 characterized in that the order in which the multiple data points are identified progresses from the edge of the collection of data points representing the object.

6. A computer program as claimed in claim 4 characterized in that data points fulfilling the conditional criterion are not included in the collection of detected data points until the point by point progression of data point identification is completed.

7. A computer program product according to claim 1 characterized in that the pre-determined threshold lies within a range between 70% and 90% and preferably within a range between 75% and 85% and preferably with the value of 80%.

8. A segmentation algorithm comprising a method according to claim 1.

9. A computer program product arranged to display images acquired from medical imaging equipment comprising a computer program product according to claim 1.

10. A workstation comprising a computer program product according to claim 1.

11. A PACS system comprising a product according to claim 1.
